(19) United States
(12) Patent Application Publication
(10) Pub. No.: US 2023/0279889 A1
(43) Pub. Date: Sep. 7, 2023

(54) MANUFACTURING METHOD OF HANDLE WITH FASTENING PORTION

(71) Applicant: TING-JUI WANG, New Taipei City (TW)

(72) Inventor: TING-JUI WANG, New Taipei City (TW)

(21) Appl. No.: 18/314,165

(22) Filed: May 9, 2023

Related U.S. Application Data
(63) Continuation of application No. 17/167,112, filed on Feb. 4, 2021.
Application No. 17/167,112 is a continuation-in-part of application No. 16/843,905, filed on Apr. 9, 2020.

(51) Int. Cl. F16B 21/06

(52) U.S. Cl. CPC F16B 21/065

(57) ABSTRACT

A handle with a fastening portion includes a body and a second fastening portion. The second fastening portion is provided on one end of the body, and includes a neck configured to be receivingly fastened into, assembled into or fitted with a coupling counterpart. Thus, the handle may be assembled with a coupling counterpart when in use, and the handle may be removed from the coupling counterpart when not in use.

### CROSS-REFERENCE TO RELATED APPLICATION

This application is a continuation application of U.S. application Ser. No. 17/167,112 filed on Feb. 4, 2021, which is a CIP of U.S. application Ser. No. 16/843,905 filed on Apr. 9, 2020, the entire contents both of which are hereby incorporated by reference for which priority is claimed under 35 U.S.C. § 120.

### BACKGROUND OF THE INVENTION

### 1. Field of the Invention

The present disclosure relates to a handle with a fastening portion, and in particular to a handle with a fastening portion, the handle being assembled to a coupling counterpart when in use and being removed from the coupling counterpart when not in use so as to achieve easy operation and collision prevention.

### 2. DESCRIPTION OF THE RELATED ART

To offer portability and transportation convenience of a common object, a handle is usually provided on the object (for example, a suitcase, a box, a door . . . etc.) for a user to easily apply a force for purposes of portability and transportation.

However, in the conventional handle above, two ends of the handle are locked, connected and fixed on outer sides of the object by using screws and cannot be collapsed after having been provided, such that the handle constantly protrudes from the surface of the object, causing interference in the arrangement of the object (because the protruding handle does not allow the object to be leaned close to a wall surface) as well as collisions when not in use. Further, after use for a certain amount of time, the handle may even fall off due to loosening of the screws and can no longer be used.

Therefore, the present disclosure aims to disclose a disclosure of a handle with a fastening portion, the handle being assembled to a coupling counterpart when in use and being removed from the coupling counterpart when not in use so as to achieve objects of easy operation and collision prevention.

### BRIEF SUMMARY OF THE INVENTION

In view of the issues and drawbacks of the prior art, the inventor has dedicated to research and development of a handle with a fastening portion, the handle being assembled to a coupling counterpart when in use and being removed from the coupling counterpart when not in use so as to achieve objects of easy operation and collision prevention.

To achieve the above object and other objects, the present disclosure provides a handle with a fastening portion, the handle including a body and a second fastening portion. The second fastening portion is provided on one end of the body, and includes a neck configured to be receivingly fastened into, assembled into or fitted with a coupling counterpart.

In the foregoing handle with a fastening portion, a fixing connection portion is provided on the other end of the body.

In the foregoing handle with a fastening portion, the second fastening portion is configured to enter a receiving fastening portion of the coupling counterpart and to be receivingly fastened in a fitting fastening portion of the coupling counterpart by the neck.

In the foregoing handle with a fastening portion, once the neck is receivingly fastened in the fitting fastening portion, the neck is receivingly fastened or locked in a fixing connection portion on the other end of the body by a coupling member so as to be assembled with the coupling counterpart.

In the foregoing handle with a fastening portion, a second fastening portion is provided on each of both ends of the handle, and the coupling counterpart includes two receiving fastening portions and two fitting fastening portions. The second fastening portions are configured to first enter the receiving fastening portions of the coupling counterpart, and the necks are respectively receivingly fastened in the fitting fastening portions of the coupling counterpart so as to be fastening connected with the coupling counterpart.

In the foregoing handle with a fastening portion, the second fastening portion is configured to enter a receiving fastening portion of the coupling counterpart, and the neck is receivingly fastened in an intermediate portion of the coupling counterpart and then fittingly fastened at a fitting fastening portion of the coupling counterpart by a fitted fastening portion of the second fastening portion.

In the foregoing handle with a fastening portion, the second fastening portion includes an abutting element. The abutting element is configured to be receivingly fastened in or to enter the fitting fastening portion, so as to abut against the body and the coupling counterpart or to abut the second fastening portion and the coupling counterpart.

In the foregoing handle with a fastening portion, the neck includes a stopping portion, the stopping portion is provided in the body, and an abutting element is provided between the body and the stopping portion. Two ends of the abutting element are respectively abutted against the body and the stopping portion, so as to constantly locate the neck in a withdrawn position.

In the foregoing handle with a fastening portion, the neck may be pulled out from the withdrawn position by an external force so as to enter the fitting fastening portion and be fastening connected.

In the foregoing handle with a fastening portion, the neck includes a stopping portion, the stopping portion is provided in the body, and an abutting element is provided between the body and the stopping portion. Two ends of the abutting element are respectively abutted against the body and the stopping portion, so as to constantly locate the neck in a withdrawn position.

In the foregoing handle with a fastening portion, the neck may be pulled out from the withdrawn position by an external force so as to enter the intermediate portion and then be fastening connected at the fitting fastening portion by the fitted fastening portion.

In the foregoing handle with a fastening portion, the stopping portion is arranged on a first fastening portion, which is assembled with the body.

In the foregoing handle with a fastening portion, the abutting element is an elastic piece, an elastic column, a spring or an elastic fastener.

In the foregoing handle with a fastening portion, the second fastening portion includes a neck, the neck is a material storage space, and the body or the second fastening portion is configured to be pressed by an external force such that the material of the coupling counterpart enters or flows into the material storage space so as to assemble the handle with the coupling counterpart.

In the foregoing handle with a fastening portion, the external force may be further pressed on a shoulder on the body.

In the foregoing handle with a fastening portion, the second fastening portion is pressed by an external force to form a neck, which is a material retaining portion for retaining the coupling counterpart so as to be assembled with the coupling counterpart.

In the foregoing handle with a fastening portion, the second fastening portion is a neck, and the body or the neck has a welding surface configured to be welded to a corresponding portion of the coupling counterpart.

In the foregoing handle with a fastening portion, the body or the second fastening portion is configured to be welded by solder to the corresponding portion of the coupling counterpart, and the corresponding portion is a corresponding opening, groove, plane, recess or protrusion.

In the foregoing handle with a fastening portion, the handle is picked up by a tool and placed at the coupling counterpart so as to perform assembly.

In the foregoing handle with a fastening portion, the handle is picked up by a tool and placed at an assembly position of the coupling counterpart, or is picked up by a tool and compared with an assembly position of the coupling counterpart by a comparison device, so as to be accurately placed on the assembly position of the coupling counterpart.

In the foregoing handle with a fastening portion, the handle is configured to be placed on a carrier, which includes or does not include a cover.

In the foregoing handle with a fastening portion, the body includes a first fastening portion, which is assembled or connected to or integrally formed at the second fastening portion or the neck.

In the foregoing handle with a fastening portion, the first fastening portion is assembled with the body, movably assembled with the body, or assembled with the body by a coupler.

In the foregoing handle with a fastening portion, the coupler is a rod, a fastener, a rivet or a pin.

In the foregoing handle with a fastening portion, the body includes a material extrusion portion for extruding the material of the coupling counterpart into the neck.

In the foregoing handle with a fastening portion, the handle includes an anti-slip portion for providing an anti-slip effect, and the anti-slip portion is a protrusion, a recess, an anti-slip body, a planar surface, a toothed surface, a step surface, an arc surface, a curved surface or an inclined surface.

In the foregoing handle with a fastening portion, the coupling counterpart is a housing, a board, a box, a circuit board, a plate, a metal body or a plastic body.

In the foregoing handle with a fastening portion, the fitting fastening portion is a protrusion, a recess or a blocking structure configured to interfere with or block the body, the second fastening portion or the handle.

In the foregoing handle with a fastening portion, the intermediate portion is a protrusion, a recess or a blocking structure configured to interfere with or block the body, the second fastening portion, the fitting fastening portion or the handle.

In the foregoing handle with a fastening portion, the neck includes an operating portion extending on an outer side of the handle and configured to control movement of the second fastening portion.

In the foregoing handle with a fastening portion, the handle includes two second fastening portions. One of the second fastening portions is configured to enter a receiving fastening portion of the coupling counterpart, enter an intermediate portion of the coupling counterpart and then be receivingly fastened in a fitting fastening portion of the coupling counterpart. The other second fastening portion is configured to enter a receiving fastening portion of the coupling counterpart, and then be receivingly fastened in a fitting fastening portion of the coupling counterpart.

In the foregoing handle with a fastening portion, the handle includes two second fastening portions. The second fastening portions are configured to enter a receiving fastening portion of the coupling counterpart, enter an intermediate portion of the coupling counterpart, and then be receivingly fastened in a fitting fastening portion of the coupling counterpart.

In the foregoing handle with a fastening portion, the handle includes a second fastening portion and a fixing connection portion. The second fastening portion is configured to enter a receiving fastening portion of the coupling counterpart, enter an intermediate portion of the coupling counterpart, and then be receivingly fastened in a fitting fastening portion of the coupling counterpart. The fixing connection portion is configured to be fixed at the coupling counterpart.

In the foregoing handle with a fastening portion, the fixing connection portion is a screw locking portion, a second fastening portion, an elastic second fastening portion, a hook second fastening portion, a nut portion or a screw portion.

In the foregoing handle with a fastening portion, the handle includes at least one coupling portion configured to enable the second fastening portion to be receivingly fastened into at least one fitting fastening portion of the coupling counterpart, and the coupling portion is receivingly fastened into at least one securing portion of the coupling counterpart so as to limit the horizontal movement, vertical movement or rotational movement of the second fastening portion. Alternatively, the coupling portion is configured to abut against or interference with the surface of the coupling counterpart so as to limit the horizontal movement, vertical movement or rotational movement of the second fastening portion.

In the foregoing handle with a fastening portion, the handle includes at least one coupling portion. The second fastening portion is first receivingly fastened in at least one fitting fastening portion of the coupling counterpart, and the coupling portion is then receivingly fastened in at least one securing portion of the coupling counterpart so as to limit the horizontal movement, vertical movement or rotational movement of the second fastening portion. Alternatively, the coupling portion is configured to abut against or interference with the surface of the coupling counterpart so as to limit the horizontal movement, vertical movement or rotational movement of the second fastening portion.

In the foregoing handle with a fastening portion, the coupling portion is an elastic fastener having an elastic fastening arm.

In the foregoing handle with a fastening portion, the securing portion is in communication with the fitting fastening portion, or the securing portion is not in communication with the fitting fastening portion.

In the foregoing handle with a fastening portion, the body, the second fastening portion or the neck of the handle is formed by in-mold plastic injection.

In the foregoing handle with a fastening portion, the body, the second fastening portion, the neck or the coupling portion of the handle is formed by in -mold plastic injection.

The foregoing handle with a fastening portion is formed by lathing, forging, injection, in-mold injection, stamping, bending, mutual movable assembly or assembly.

The foregoing handle with a fastening portion is formed of a metal material, a non-metal material or a plastic material.

In the foregoing handle with a fastening portion, the width of the second fastening portion is less than that of the receiving fastening portion, and the width of the fitting fastening portion is more than that of the neck and less than that of the second fastening portion.

In the foregoing handle with a fastening portion, the width of the second fastening portion is less than that of the receiving fastening portion, and the width of the fitting fastening portion or the intermediate portion is more than that of the neck or the fitted fastening portion and less than that of the second fastening portion.

In the foregoing handle with a fastening portion, the body or the second fastening portion includes an interference portion configured to interfere with or block the coupling counterpart.

In the foregoing handle with a fastening portion, the abutting element may be a formed integral with the handle.

In the foregoing handle with a fastening portion, the abutting element and the handle are mutually connected by a connecting portion in between.

In the foregoing handle with a fastening portion, the fixing connection portion may be a formed integral with the handle, the fixing connection portion is bolt connected to the handle, the fixing connection portion is rivet connected, fastening connected, expansion connected, welding connected, lock connected, fittingly connected or hot-melt connected to the handle, or the fixing connection portion and the handle are assembled by in-mold injection.

In the foregoing handle with a fastening portion, an anti-rotation portion is provided on the surface of the fixing connection portion, and is configured to prevent disengagement or rotation of the fixing connection portion assembled on the body.

In the foregoing handle with a fastening portion, the anti-rotation portion is an embossed pattern, a toothed pattern, a polygon, a protrusion, a recess, a planar portion, an arc portion, a curved portion, a section portion, a slot or a hole.

In the foregoing handle with a fastening portion, the neck is single-grooved or dual grooved, or a column smaller than the body or the second fastening portion.

In the foregoing handle with a fastening portion, the anti-slip portion is a recess or a protrusion configured to prevent the handle from surface shrinking or indentation caused by in-mold plastic injection during manufacturing of the handle.

In the foregoing handle with a fastening portion, the body or the second fastening portion has an electroplated layer, which is a zinc-plated layer, a nickel-plated layer, a tin-plated layer, a chromium-plated layer, an anode layer or a copper-plated layer.

In the foregoing handle with a fastening portion, the body or the second fastening portion has a paint layer.

In the foregoing handle with a fastening portion, the body or the second fastening portion has a plastic color sleeve or a plastic layer.

In the foregoing handle with a fastening portion, the body or the second fastening portion is made of a metal, a non-metal material or a plastic material, or the surface of the head or the body has a surface of an antirust layer.

In the foregoing handle with a fastening portion, the body or the second fastening portion is configured to be placed in a conductive fluid, and the material of the antirust layer is attached to the head or the body by the conductive fluid.

In the foregoing handle with a fastening portion, the body, the second fastening portion, the conductive fluid or the antirust material is current conductive, so as to move and attach the material of the antirust layer to the head or the body.

In the foregoing handle with a fastening portion, the body is formed in a mold by plastic or metal injection, wherein the mold includes a flow channel so that liquid plastic or metal passes through the flow channel, enters the mold and is cured to form the body.

In the foregoing handle with a fastening portion, wherein the first fastening portion and the coupling portion are assembled by means of rivet connection, expansion connection, welding connection or lock connection.

In the foregoing handle with a fastening portion, a float margin is present between the body and the first fastening portion, a float margin is present between the body and the coupler, or a float margin is present between the first fastening portion and the coupler.

In the foregoing handle with a fastening portion, the first fastening portion is assembled with the body by a coupler, and a float margin is present between the body and the coupler, or a float margin is present between the first fastening portion and the coupler.

In the foregoing handle with a fastening portion, the float margin is between 0.0001 mm and 100 mm.

In the foregoing handle with a fastening portion, the body and the second fastening portion are assembled by a coupler in between.

In the foregoing handle with a fastening portion, the coupler includes a head, an expansion connection portion and a blocking portion and passes through the body and the second fastening portion, the blocking portion is provided at the expansion connection portion, the head is abutted against the body, the expansion connection portions is abutted against the blocking portion, and the expansion connection portion and the blocking portion are provided at the second fastening portion.

The foregoing handle with a fastening portion further includes an elastic element. One end of the elastic element presses against the second fastening portion, and the other end of the elastic element presses against the blocking portion.

In the foregoing handle with a fastening portion, the coupler includes a head and an expansion connection portion, and passes through the body and the second fastening portion, the expansion connection portion is abutted against the body, and the head is provided at the second fastening portion.

The foregoing handle with a fastening portion further includes an elastic element. One end of the elastic element presses against the second fastening portion, and the other end of the elastic element presses against the head.

In the foregoing handle with a fastening portion, the body includes an inserted portion, and the coupler passes through the inserted portion so as to assemble the body and the second fastening portion.

In the foregoing handle with a fastening portion, the second fastening portion includes an anti-rotation portion, and the coupling counterpart includes a corresponding anti-rotation portion configured to correspondingly prevent rotation of the second fastening portion, to position the direction of the second fastening portion, or to position an assembly position of the second fastening portion and the coupling counterpart.

In the foregoing handle with a fastening portion, a solder layer configured to be heated, cooled and then cured is present between the body, the first fastening portion or the second fastening portion and the coupling counterpart, wherein the coupling counterpart is a PCB.

In the foregoing handle with a fastening portion, the material of the coupling counterpart flows into, enters or is extruded into the second fastening portion once the coupling counterpart is pressed.

The foregoing handle with a fastening portion further includes a corresponding fixing connection portion. The corresponding fixing connection portion is fastened with the fixing connection portion and is configured to press against the coupling counterpart, so as be anti-rotated and then clamp the coupling counterpart with the body, to be welding connected and then clamp the coupling counterpart with the body, or to be welding connected, anti-rotated and then clamp the coupling counterpart with the body.

In the foregoing handle with a fastening portion, the first fastening portion or the second fastening portion is movably assembled with the body, the first fastening portion or the second fastening portion is fixedly assembled with the body, or the first fastening portion and the second fastening portion are a formed integral with the body.

In the foregoing handle with a fastening portion, a float margin is present between the body and the first fastening portion. The float margin is configured to allow material retaining portions of two first fastening portions to be inserted within a float range of the float margin into two holes of the coupling counterpart so as to be assembled with the coupling counterpart.

In the foregoing handle with a fastening portion, a float margin is present between the body and the first fastening portion. The float margin is configured to allow a material retaining portion of the first fastening portion to be inserted within a float range of the float margin into a hole of the coupling counterpart so as to be assembled with the coupling counterpart.

In the foregoing handle with a fastening portion, the inserted portion of the body is formed in a mold by plastic injection. The mold includes a flow channel and a limiting portion, so that liquid plastic or metal passes through the flow channel, enters the mold and evades the limiting portion to as to be cured to form the inserted portion of the body.

In the foregoing handle with a fastening portion, a float margin is present between the first fastening portion and the second fastening portion.

In the foregoing handle with a fastening portion, the first fastening portion and the second fastening portion are assembled by a coupler, and a float margin is present between the first fastening portion and the coupler, or a float margin is present between the second fastening portion and the coupler.

Thus, the handle with a fastening portion of the present disclosure may be assembled with a coupling counterpart when in use and be removed from the coupling counterpart when not in use, achieving effects of easy operation and collision prevention.

### BRIEF DESCRIPTION OF THE DRAWINGS

FIG. 1 is a schematic diagram of a cross section state according to a first embodiment of the present disclosure.

FIG. 2 is a first schematic diagram of an assembly state according to the first embodiment of the present disclosure.

FIG. 3 is a second schematic diagram of an assembly state according to the first embodiment of the present disclosure.

FIG. 4 is a third schematic diagram of an assembly state according to the first embodiment of the present disclosure.

FIG. 5 is a schematic diagram of a cross section state according to a second embodiment of the present disclosure.

FIG. 6 is a schematic diagram of an assembly state according to the second embodiment of the present disclosure.

FIG. 7 is a first schematic diagram of an assembly state according to a third embodiment of the present disclosure.

FIG. 8 is a second schematic diagram of an assembly state according to the third embodiment of the present disclosure.

FIG. 9 is a schematic diagram of a structure according to a fourth embodiment of the present disclosure.

FIG. 10 is a schematic diagram of an assembly state according to the fourth embodiment of the present disclosure.

FIG. 11 is a schematic diagram of a structure according to a fifth embodiment of the present disclosure.

FIG. 12 is a schematic diagram of an assembly state according to the fifth embodiment of the present disclosure.

FIG. 13 is a schematic diagram of an assembly state according to a sixth embodiment of the present disclosure.

FIG. 14 is a schematic diagram of an assembly state according to a seventh embodiment of the present disclosure.

FIG. 15 is a schematic diagram of an assembly state according to an eighth embodiment of the present disclosure.

FIG. 16 is a schematic diagram of an assembly state according to a ninth embodiment of the present disclosure.

FIG. 17 is a schematic diagram of an assembly state according to a tenth embodiment of the present disclosure.

FIG. 18 is a schematic diagram of an assembly state according to an eleventh embodiment of the present disclosure.

FIG. 19 is a schematic diagram of an assembly state according to a twelfth embodiment of the present disclosure.

FIG. 20 is a schematic diagram of an assembly state according to a thirteenth embodiment of the present disclosure.

FIG. 21 is a schematic diagram of an assembly state according to the thirteenth embodiment of the present disclosure.

FIG. 22 is a schematic diagram of an assembly state according to the thirteenth embodiment of the present disclosure.

FIG. 23 is a schematic diagram of an assembly state according to a fourteenth embodiment of the present disclosure.

FIG. 24 is a schematic diagram of a fastening connected state after assembly according to the fourteenth embodiment of the present disclosure.

FIG. 25 is a schematic diagram of an assembly state according to a fifteenth embodiment of the present disclosure.

FIG. 26 is a schematic diagram of an assembly state according to a sixteenth embodiment of the present disclosure.

FIG. 27 is a schematic diagram of an appearance according to a seventeenth embodiment of the present disclosure.

FIG. 28 is a schematic diagram of different forms of a fixing connection portion of the present disclosure.

FIG. 29 is a schematic diagram of an appearance according to an eighteenth embodiment of the present disclosure.

FIG. 30 is a schematic diagram of an appearance according to a nineteenth embodiment of the present disclosure.

FIG. 31 is a schematic diagram of an appearance according to a twentieth embodiment of the present disclosure.

FIG. 32 is a schematic diagram of an appearance according to a twenty-first embodiment of the present disclosure.

FIG. 33 is a schematic diagram of a state without a float margin.

FIG. 34 is a schematic diagram of an appearance according to a twenty-second embodiment of the present disclosure.

FIG. 35 is a schematic diagram of an appearance according to a twenty-third embodiment of the present disclosure.

FIG. 36 is a schematic diagram of an appearance according to a twenty-fourth embodiment of the present disclosure.

FIG. 37 is a schematic diagram of an assembly state according to a twenty-fifth embodiment of the present disclosure.

FIG. 38 is a schematic diagram of an assembly state according to a twenty-sixth embodiment of the present disclosure.

FIG. 39 is a schematic diagram of an assembly state according to a twenty-seventh embodiment of the present disclosure.

FIG. 40 is a schematic diagram of an assembly state according to a twenty-eighth embodiment of the present disclosure.

FIG. 41 is a schematic diagram of an assembly state according to a twenty-ninth embodiment of the present disclosure.

### DETAILED DESCRIPTION OF THE INVENTION

To fully understand the objects, features and functions of the present disclosure, details of the present disclosure are given in specific embodiments with the accompanying drawings below.

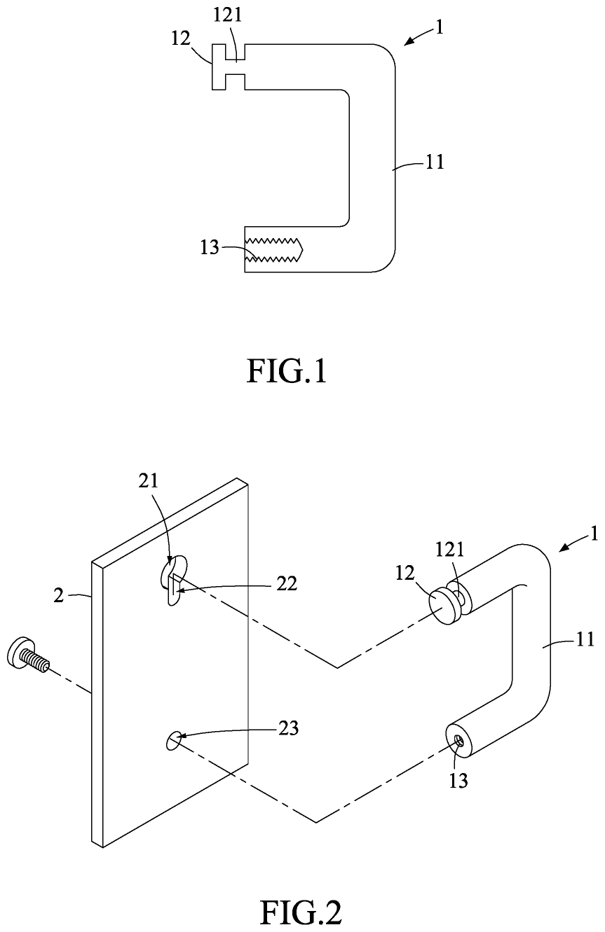

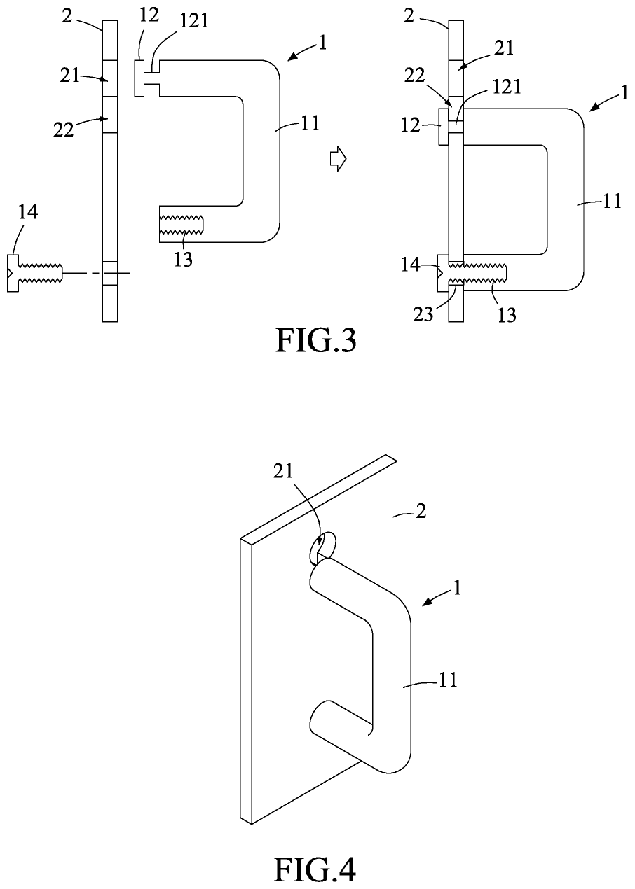

Refer to FIG. 1 to FIG. 4. As shown, the present disclosure provides a handle with a fastening portion, the handle 1 including a body 11 and a second fastening portion 12.

The second fastening portion 12 is provided on one end of the body 11, and includes a neck 121 configured to be receivingly fastened into, assembled into, or fitted with a coupling counterpart 2.

When in use, the handle 1 may be assembled with the coupling counterpart 2 by the second fastening portion 12; when not in use, the second fastening portion 12 of the handle 1 is removed from the coupling counterpart 2, achieving effects of easy operation and collision prevention.

In a preferred specific embodiment of the present disclosure, a fixing connection portion 13 is provided on the other end of the body 11. The coupling counterpart 2 includes a receiving fastening portion 21 and a fitting fastening portion 22 that are in communication with each other. Once the handle 1 enters the receiving fastening portion 21 of the coupling counterpart 2 by the second fastening portion 12, the neck 121 is receivingly fastened in the fitting fastening portion 22 of the coupling counterpart 2. Once the neck 121 is receivingly fastened in the fitting fastening portion 22, the fixing connection portion 13 corresponds to a corresponding portion 23 of the coupling counterpart 2, and a coupling member 14 is receivingly fastened or locked in the fixing connection portion 13 on the other end of the body 11, so as to assemble the handle 1 with the coupling counterpart 2 for further use. To remove the handle 1, the coupling member 14 may be removed from the fixing connection portion 13, the neck 121 is moved from the fitting fastening portion 22 to the receiving fastening portion 21, and the second fastening portion 12 is then removed from the coupling counterpart 2, so as to separate the handle 1 from the coupling counterpart 2. Thus, the handle 1 and the coupling counterpart 2 may be assembled when in use, and the handle 1 may be removed from the coupling counterpart 2 when not in use, achieving effects of easy operation and collision prevention.

In a preferred specific embodiment of the present disclosure, the coupling counterpart 2 may be a housing, a plate, a box, a circuit board, a plate, a metal body or a plastic body. Thus, the present disclosure is enabled to better meet requirements of actual applications.

In a preferred specific embodiment of the present disclosure, the fitting fastening portion 22 may be a protrusion, a recess or a blocking structure, and is configured to interfere with or block the body 11, the second fastening portion 12 or the handle 1. Thus, the present disclosure is enabled to better meet requirements of actual applications.

In a preferred specific embodiment of the present disclosure, the fixing connection portion 13 may be a screw locking portion, a second fastening portion, an elastic second fastening portion, a hook second fastening portion, a nut portion or a screw portion. Thus, the present disclosure is enabled to better meet requirements of actual applications.

In a preferred specific embodiment of the present disclosure, the fixing connection portion 13 is a formed integral with the handle 1, the fixing connection portion 13 is bolt connected to the handle 1, the fixing connection portion 12 is rivet connected, fastening connected, expansion connected, welding connected, lock connected, fittingly connected or hot-melt connected to the handle 1, or the fixing connection portion 13 and the handle 1 are assembled by in-mold injection.

In a preferred specific embodiment of the present disclosure, the handle 1 and the components thereof may be formed by turning, forging, injection, in-mold injection, stamping, bending, mutual movable assembly or assembly. Thus, the present disclosure is enabled to better meet requirements of actual applications.

In a preferred specific embodiment of the present disclosure, the handle 1 and the components thereof may be in a metal material, a non-metal material or a plastic material. Thus, the present disclosure is enabled to better meet requirements of actual applications.

In a preferred specific embodiment of the present disclosure, the body 11, the second fastening portion 12 or the neck 121 of the handle 1 is formed by plastic in-mold injection. Thus, the present disclosure is enabled to better meet requirements of actual applications.

In a preferred specific embodiment of the present disclosure, the width of the second fastening portion 12 is less than that of the receiving fastening portion 21, and the width of the fitting fastening portion 22 is more than that of the neck 121 and less than that of the second fastening portion 12. Thus, once the second fastening portion 12 enters the receiving fastening portion 21 of the coupling counterpart 2, the neck 121 is receivingly fastened in the fitting fastening portion 22 of the coupling counterpart 2, thereby enabling the handle 1 and the coupling counterpart 2 to achieve a stable coupling effect.

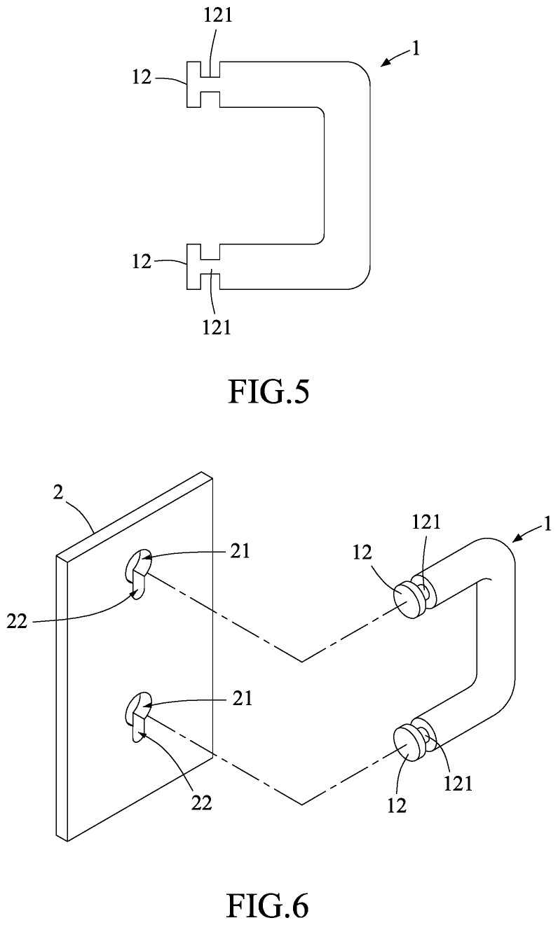

Referring to FIG. 5 and FIG. 6, as shown, in a preferred specific embodiment of the present disclosure, a second fastening portion 12 is provided on each of both ends of the handle 1, and the coupling counterpart 2 includes two receiving fastening portions 21 and two fitting fastening portions 22. The second fastening portions 12 first respectively enter the receiving fastening portions 21 of the coupling counterpart 2, and are respectively receivingly fastened in the fitting fastening portions 22 of the coupling counterpart 2 by the necks 121, so as to fastening connect the handle 1 with the coupling counterpart 2 for further use. When not in use, the necks 121 are respectively moved from the fitting fastening portions 22 to the receiving fastening portions 21 to further remove the second fastening portions 12 from the coupling counterpart 2, so as to separate the handle 1 from the coupling counterpart 2. Thus, the handle 1 may be assembled with the coupling counterpart 2 when in use, and the handle 1 may be removed from the coupling counterpart 2 when not in use, achieving effects of easy operation and collision prevention.

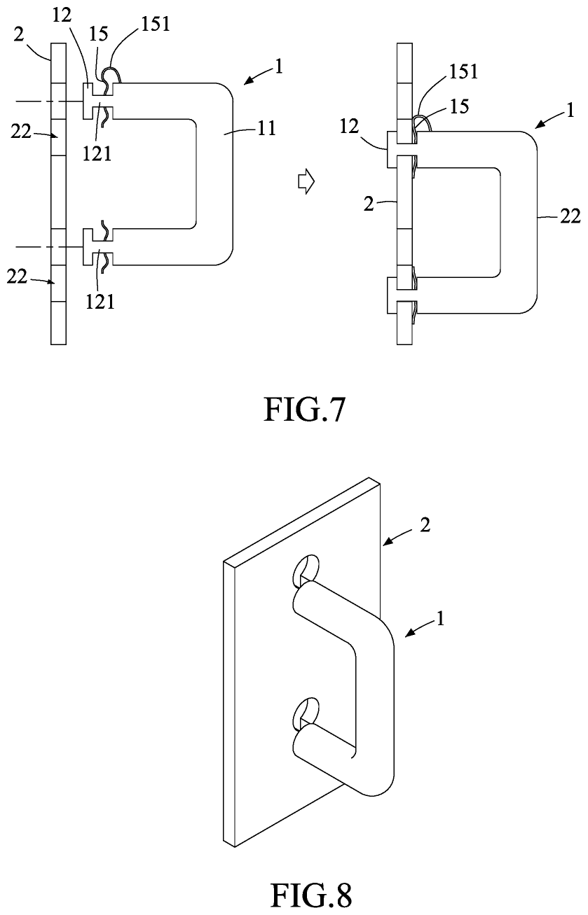

Referring to FIG. 7 and FIG. 8, as shown, in a preferred specific embodiment of the present disclosure, the second fastening portion 12 includes an abutting element 15. The abutting element 15 surrounds the neck 121, and is configured to be receivingly fastened with the fitting fastening portion 22 of the coupling counterpart 2 and to abut against the body 11 and the coupling counterpart 2. In this embodiment, the second fastening portion 12 and the abutting element 15 are two in quantity, and may also be provided as one in quantity according to requirements of actual applications. Thus, the handle 1 and the coupling counterpart 2 are enabled to achieve an effect of stable coupling using the abutting element 15.

In a preferred specific embodiment of the present disclosure, the abutting element 15 may be an elastic piece, an elastic column, a spring or an elastic fastener, and the abutting element 15 and the handle 1 may be a formed integral (not shown). Thus, the present disclosure is enabled to better meet requirements of actual applications.

In a preferred specific embodiment of the present disclosure, the abutting element 15 and the handle 1 may be connected to each other by a connecting portion 151 in between. Thus, the present disclosure is enabled to better meet requirements of actual applications.

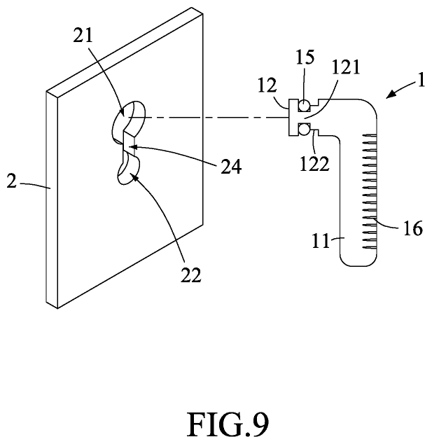

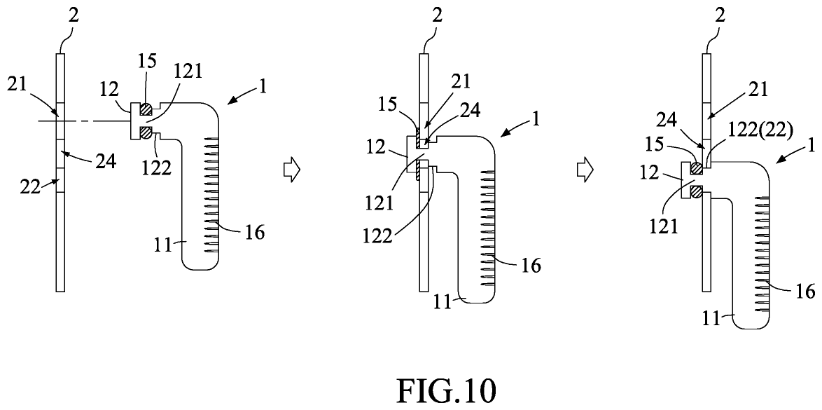

Referring to FIG. 9 and FIG. 10, as shown, in a preferred specific embodiment of the present disclosure, the second fastening portion includes an abutting element 15, and includes a fitted fastening portion 122. The coupling counterpart 2 includes a receiving fastening portion 21, a fitting fastening portion 22 and an intermediate portion 24 that are in communication, wherein the intermediate portion 24 is provided between the receiving fastening portion 21 and the fitting fastening portion 22. The second fastening portion 12 is configured to enter the receiving fastening portion 21, the neck 121 is receivingly fastened in the intermediate portion 24, the fitted fastening portion 122 of the second fastening portion 12 is fittingly fastened in the fitting fastening portion 22, and the abutting element 15 is receivingly fastened or enters the fitting fastening portion 22 so as to abut against the second fastening portion 12 and the coupling counterpart 2. Thus, the handle 1 and the coupling counterpart 2 are enabled to achieve an effect of stable coupling using the abutting element 15.

In a preferred specific embodiment of the present disclosure, the handle includes an anti-slip portion 16 for providing an anti-slip effect. The anti-slip portion 16 may be a protrusion, a recess, an anti-slip body, a plane, a toothed portion, a step portion, an arc surface, a curved surface or an inclined surface. Thus, the present disclosure is enabled to better meet requirements of actual applications.

In a preferred specific embodiment of the present disclosure, the intermediate portion 24 may be a protrusion, a recess or a blocking structure, and is configured to interfere with or block the body 11, the second fastening portion 12, the fitted fastening portion 122 or the handle 1. Thus, the present disclosure is enabled to better meet requirements of actual applications.

In a preferred specific embodiment of the present disclosure, the width of the second fastening portion 12 is less than that of the receiving fastening portion 21, and the width of the fitting fastening portion 22 or the intermediate portion 24 is more than that of the neck 121 or the fitted fastening portion 122 and less than that of the second fastening portion 12. Thus, the second fastening portion 12 is allowed to enter the receiving fastening portion 21, the neck 121 is receivingly fastened in the intermediate portion 24, and the fitted fastening portion 122 of the second fastening portion 12 is fittingly fastened in the fitting fastening portion 22, enabling the handle 1 and the coupling counterpart 2 to achieve an effect of stable coupling.

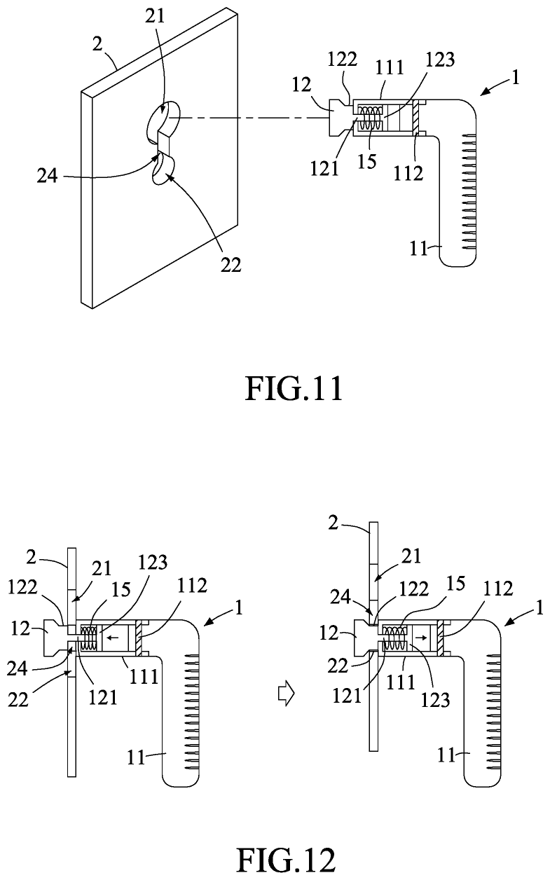

Referring to FIG. 11 and FIG. 12, as shown, in a preferred specific embodiment of the present disclosure, the neck includes a stopping portion 123, which is provided in the body 11. An abutting element 15 is provided between the body 11 and the stopping portion 123, two ends of the abutting element 15 are respectively abutted against the body 11 and the stopping portion 123, and the abutting element 15 is configured to constantly locate the neck 121 in a withdrawn position. When in use, the neck 121 is pulled out from the withdrawn position by an external force, so as to enter the intermediate portion 24 and be fastening connected to the fitting fastening portion 22 by the fitted fastening portion 122. Thus, the handle 1 and the coupling counterpart 2 are enabled to achieve an effect of stable coupling.

In a preferred specific embodiment of the present disclosure, the body 11 includes a first fastening portion 111. The first fastening portion 111 is assembled or connected to or is integrally formed at the second fastening portion 12 and the neck 121, and the stopping portion 123 is placed in the first fastening portion 111. The first fastening portion 111 is assembled or movably assembled with the body 11, or is assembled with the body 11 by a coupler 112. In this embodiment, the first fastening portion 111 and the body 11 are assembled by a coupler 112, so as to enable the first fastening portion 111 and the body 11 to achieve an effect of stable coupling.

In a preferred specific embodiment of the present disclosure, the coupler 112 may be a rod, a fastener, a rivet or a pin. Thus, the present disclosure is enabled to better meet requirements of actual applications.

In a preferred specific embodiment of the present disclosure, the first fastening portion 111 (or the second fastening portion 12) may be movably assembled with the body 11, the first fastening portion 111 may be fixedly assembled with the body 11, or the first fastening portion 111 may be a formed integral with the body 11. Thus, the present disclosure is enabled to better meet requirements of actual applications.

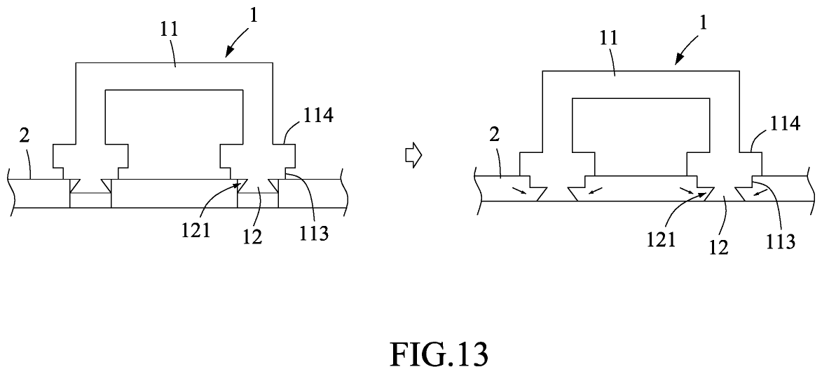

Referring to FIG. 13, as shown, in a preferred specific embodiment of the present disclosure, the second fastening portion 12 includes a neck 121, which is a material storage space, and the body 11 includes a material extrusion portion 113. The body 11 or the second fastening portion 12 is pressed by an external force, such that the material of the coupling counterpart 2 enters or flows into the material storage space and the material extrusion portion 113, so as to assemble the handle 1 with the coupling counterpart 2.

In a preferred specific embodiment of the present disclosure, the external force may further press upon a shoulder 114 of the body 11, hence achieving an effect of easy application of force.

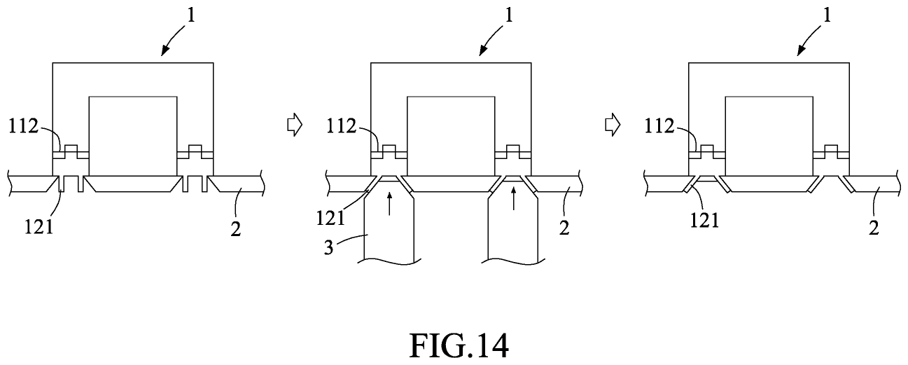

Referring to FIG. 14, as shown, in a preferred specific embodiment of the present disclosure, the second fastening portion 12 is pressed by an external force of a tool 3 to form a neck 121. The neck 121 is a material retaining portion configured to retain the coupling counterpart 2 and to assemble the handle 1 with the coupling counterpart 2.

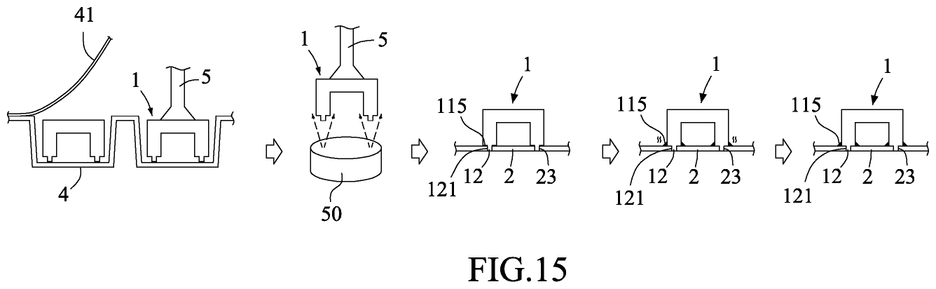

Referring to FIG. 15, as shown, in a preferred specific embodiment of the present disclosure, the handle 1 is placed on a carrier 4, which includes a cover 41 or does not include a cover 41. Further, once the handle 1 is picked up by a tool 5, an assembly position of the coupling counterpart 2 is compared by a comparison device 50, so as to accurately place the handle 1 on the assembly position of the coupling counterpart 2 and to assemble the handle 1 with the coupling counterpart 2.

In a preferred specific embodiment of the present disclosure, the second fastening portion 12 is a neck, and the body 11 or the neck 12 has a welding surface 115 configured to be welded to a corresponding portion 23 of the coupling counterpart 2, so as to stably assemble the handle 1 with the coupling counterpart 2.

In a preferred specific embodiment of the present disclosure, the body 11 or the second fastening portion 12 is configured to be welded to the corresponding portion 23 of the coupling counterpart 2 by solder (that is, the welding surface 115), wherein the corresponding portion 23 is a corresponding opening, groove, plane, recess or protrusion. Thus, the present disclosure is enabled to better meet requirements of actual applications.

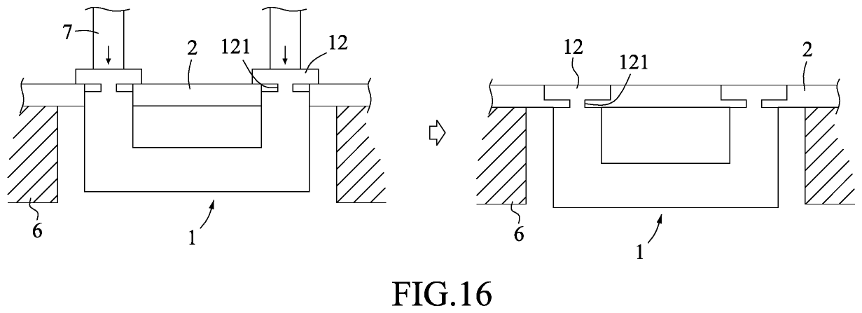

Referring to FIG. 16, as shown, in a preferred specific embodiment of the present disclosure, the second fastening portion 12 includes a neck 121, which is a material storage space. The coupling counterpart 2 may be provided at a support mold 6, and the second fastening portion 12 (or the body 11) is pressed by a downward pressing mold 7, such that the material of the coupling counterpart 2 enters or flows into the material storage space (that is, the neck 121), so as to assemble the handle 1 with the coupling counterpart 2.

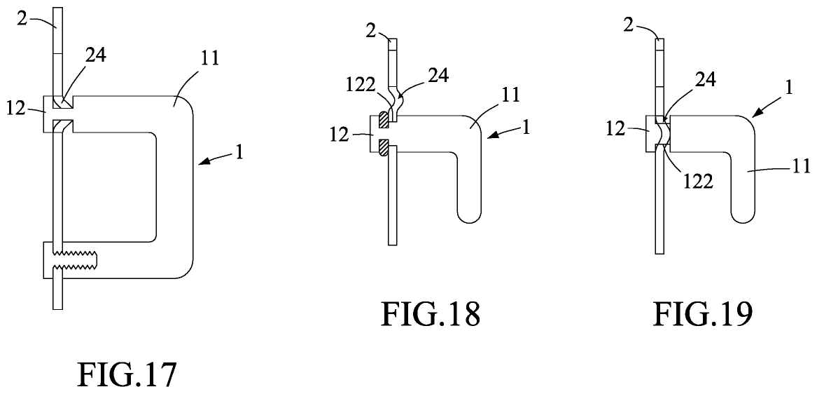

Referring to FIG. 17 to FIG. 19, as shown, in a preferred specific embodiment of the present disclosure, the intermediate portion 24 of the coupling counterpart 2 is a blocking structure configured to interfere with or block the body 11, the second fastening portion 12, the fitted fastening portion 122 or the handle 1. Thus, the present disclosure is enabled to better meet requirements of actual applications.

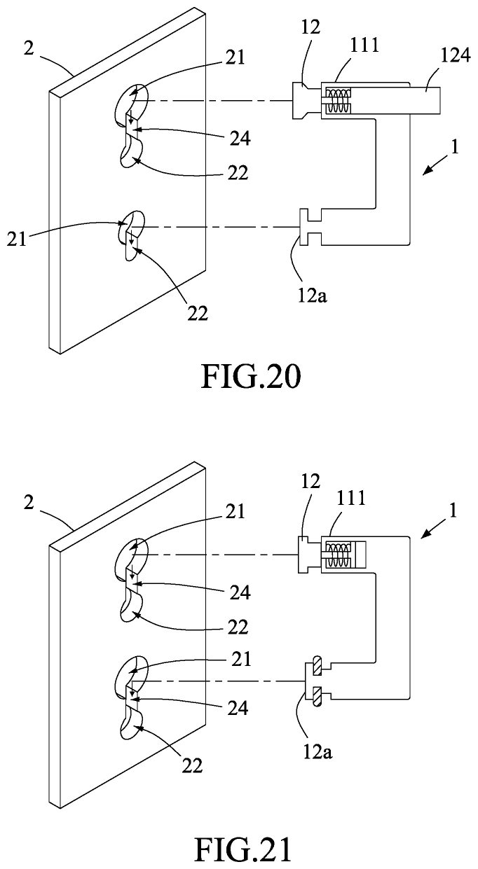

Referring to FIG. 20, as shown, in a preferred specific embodiment of the present disclosure, the handle 1 includes two second fastening portions 12 and 12a, and the neck 121 of one of the second fastening portions 12 includes an operating portion 124 extending on an outer side of the handle and configured to control movement of the second fastening portion 12. For assembly, one of the second fastening portions 12 is configured to enter a receiving fastening portion 21 of the coupling counterpart 2, enter an intermediate portion 24 of the coupling counterpart 2, and be receivingly fastened in a fitting fastening portion 22 of the coupling counterpart 2; the other fastening portion 12a is configured to enter a receiving fastening portion 21 of the coupling counterpart 2 and is then receivingly fitted into a fitting fastening portion 22 of the coupling counterpart 2, so as to enable the handle 1 and the coupling counterpart 2 to achieve an effect of stable assembly.

Referring to FIG. 21, as shown, in a preferred specific embodiment of the present disclosure, the handle 1 includes two second fastening portions 12 and 12a. The second fastening portions 12 and 12a are configured to enter a receiving fastening portion 21 of the coupling counterpart 2, enter an intermediate portion 24 of the coupling counterpart 2, and be receivingly fastened in a fitting fastening portion 22 of the coupling counterpart 2, so as to enable the handle 1 and the coupling counterpart 2 to achieve an effect of stable assembly.

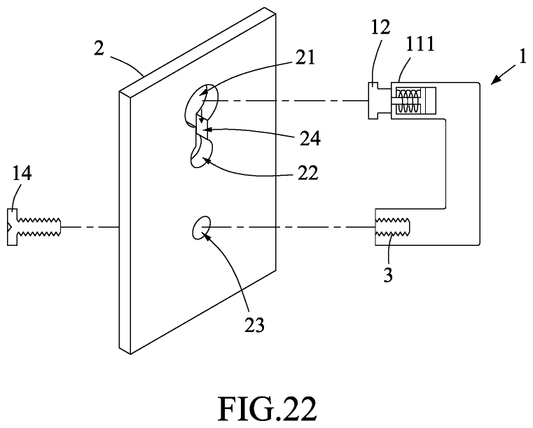

Referring to FIG. 22, as shown, in a preferred specific embodiment of the present disclosure, the handle 1 includes a second fastening portion 12 and a fixing connection portion 13. The second fastening portion 12 is configured to enter a receiving fastening portion 21 of the coupling counterpart 2, enter an intermediate portion 24 of the coupling counterpart 2, and be receivingly fastened in a fitting fastening portion 22 of the coupling counterpart 2. The fixing connection portion 13 is configured to first correspond to a corresponding portion 23 of the coupling counterpart, and then be matchingly fixedly at the coupling counterpart 2 by a coupling member 14, so as to enable the handle 1 and the coupling counterpart 2 to achieve an effect of stable assembly.

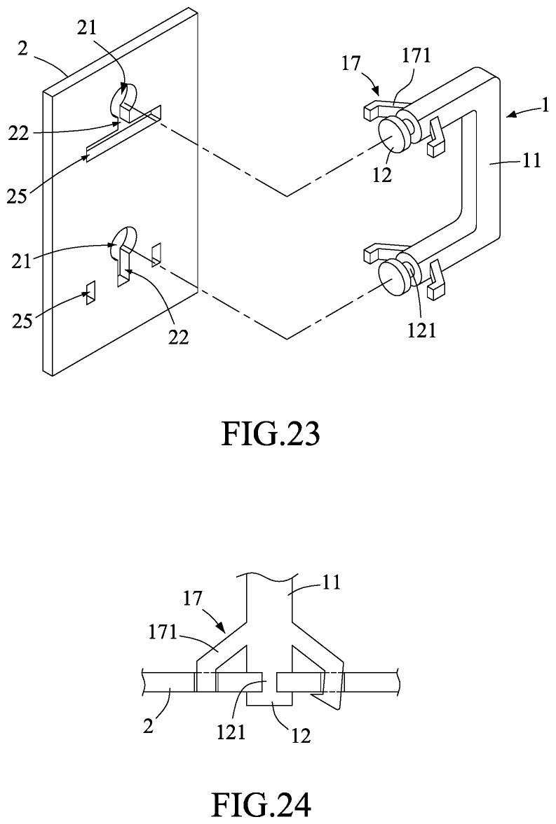

Referring to FIG. 23 and FIG. 24, as shown, in a preferred specific embodiment of the present disclosure, the handle 1 includes at least one coupling portion 17. To assemble the handle 1 with the coupling counterpart 2, the second fastening portion 12 is first receivingly fastened in at least one receiving fastening portion 21 of the coupling counterpart 2, and is then receivingly fastened in at least one securing portion 25 of the coupling counterpart 2 by the coupling portion 17, so as to limit horizontal movement, vertical movement or rotational movement of the second fastening portion 12 (or the coupling portion 17 is configured to abut against or interfere with the surface of the coupling counterpart 2 so as to limit horizontal movement, vertical movement or rotational movement of the second fastening portion 12). Thus, the handle 1 and the coupling counterpart 2 are enabled to achieve an effect of stable assembly.

In a preferred specific embodiment of the present disclosure, the coupling portion 17 is four in quantity, every two coupling portions 17 are provided on each of both sides of a second fastening portion 12, and the securing portion 25 is in a quantity corresponding to the quantity of the coupling portions 17. Thus, the handle 1 and the coupling counterpart 2 are enabled to achieve an effect of stable assembly.

In a preferred specific embodiment of the present disclosure, the coupling portion 17 is an elastic fastener having an elastic fastening arm 171. Thus, the coupling portion 17 is enabled to be tightly fastened at the securing portion 25 by the elastic fastening arm 171, so as to enable the handle 1 and the coupling counterpart 2 to achieve an effect of stable assembly.

In a preferred specific embodiment of the present disclosure, the securing portion 25 is in communication with the fitting fastening portion 22, or the securing portion 25 is not in communication with the fitting fastening portion 22. Thus, the present disclosure is enabled to better meet requirements of actual applications.

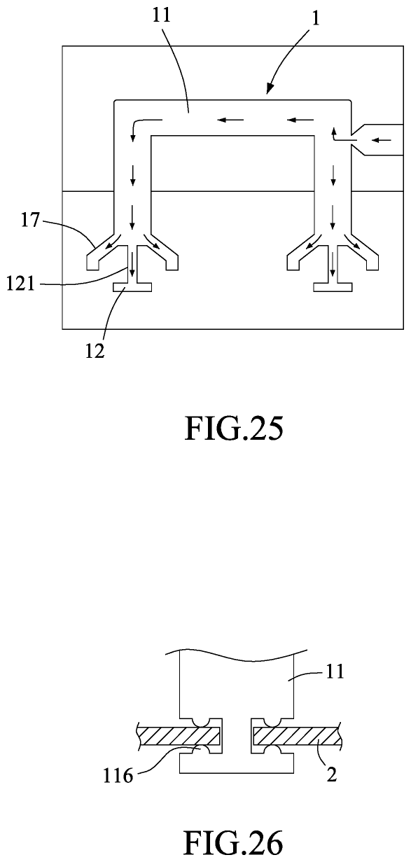

Referring to FIG. 25, as shown, in a preferred specific embodiment of the present disclosure, the body 11, the second fastening portion 12, the neck 121 or the coupling portion 17 of the handle 1 is formed by plastic in-mold injection. Thus, the present disclosure is enabled to better meet requirements of actual applications.

Referring to FIG. 26, as shown, in a preferred specific embodiment of the present disclosure, the body 11 (or the second fastening portion 12) includes an interference portion 116 configured to interfere with or block the coupling counterpart 2. Thus, the handle 1 and the coupling counterpart 2 are enabled to achieve an effect of stable assembly.

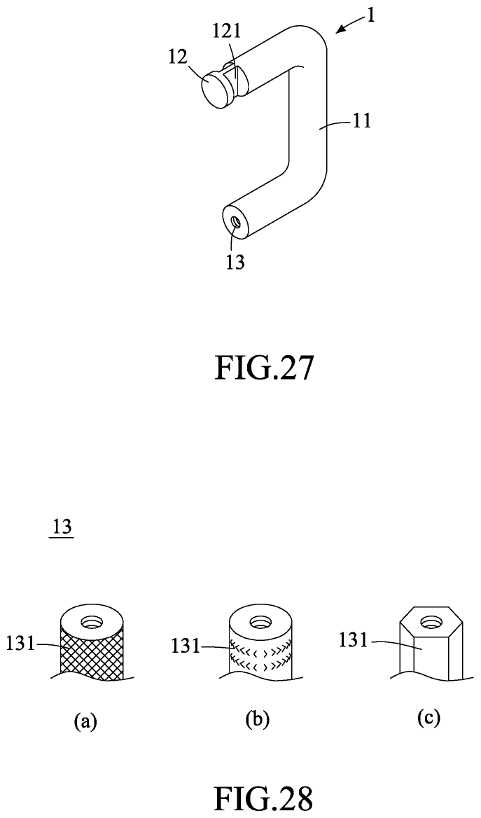

Referring to FIG. 27, as shown, in a preferred specific embodiment of the present disclosure, the second fastening portion 12 is provided on one end of the body 11, and includes a flat neck 121 configured to be receivingly fastened into, assembled into or fitted with a coupling counterpart. The neck 121 may be single-grooved or dual-grooved, or a column smaller than the body or the second fastening portion. Thus, the present disclosure is enabled to better meet requirements of actual applications.

Referring to FIG. 28, as shown, in a preferred specific embodiment of the present disclosure, an anti-rotation portion 131 is provided on the surface of the fixing connection portion 13, and is configured to prevent the fixing connection portion 13 assembled at the body 11 from departing or rotating. The anti-rotation portion 131 is an embossed pattern (as part a in FIG. 28), a toothed pattern (as part b in FIG. 28), a polygon (as part c in FIG. 28), a protrusion, a recess, a plane, an arc surface, a curved surface, a section portion, a slot or a hole. Thus, the present disclosure is enabled to better meet requirements of actual applications.

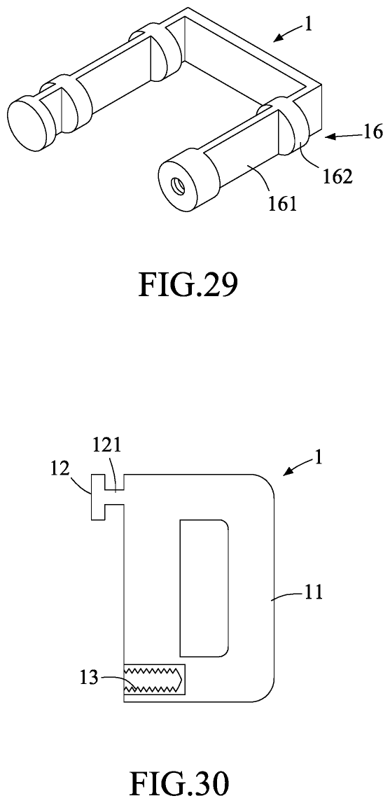

Referring to FIG. 29, as shown, in a preferred specific embodiment of the present disclosure, the anti-slip portion 16 is a recess 161 or a protrusion 162, and is configured to avoid shrinkage or recess of the surface caused during the manufacturing process of plastic in-mold injection of the handle 1. Thus, the present disclosure is enabled to better meet requirements of actual applications.

In a preferred specific embodiment of the present disclosure, the body 11 or the second fastening portion 12 includes an electroplated layer, which may be a zinc-plated layer, a nickel-plated layer, a tin-plated layer, a chromium-plated layer, an anode layer or a copper-plated layer. For manufacturing, the body 11 or the second fastening portion 12 may be placed in a conductive fluid, and the electroplated layer substance becomes attached to the body 11 or the second fastening portion 12 using the conductive fluid 8. The body 11, the second fastening portion 12, the conductive fluid or the electroplated layer substance is current conductive, such that the electroplated layer substance can be moved and attached to the body 11 or the second fastening portion 12. Thus, the electroplated layer may serve as protection for the body 11 or the second fastening portion 12 to prolong the durability of the body 11 or the second fastening portion 12.

Further, the body 11 or the second fastening portion 12 is made of a metal material, a non-metal material or a plastic material. The body 11 or the second fastening portion 12 has a paint layer, a plastic color sleeve or a plastic layer (not shown) that serves as protection for the body 11 or the second fastening portion 12 and prolongs the durability of the body 11 or the second fastening portion 12, thereby responding to requirements of different utilization conditions.

In a preferred specific embodiment of the present disclosure, the body 11 or the second fastening portion 12 has an antirust surface. During manufacturing, the body 11 or the second fastening portion 12 may be placed in a conductive fluid, the antirust substance becomes attached to the body 11 or the second fastening portion 12 using the conductive fluid, and the body 11, the second fastening portion 12, the conductive fluid 8 and the antirust substance are electric current conductive, such that the electroplated layer substance 80a can be moved and attached to the body 11 or the second fastening portion 12. Thus, the electroplated layer may serve as protection for the body 11 or the second fastening portion 12 to prolong the durability of the body 11 or the second fastening portion 12.

Referring to FIG. 30, as shown, in a preferred specific embodiment of the present disclosure, the body 11 of the handle 1 may be a loop, and the second fastening portion 12 and the fixing connection portion are provided on one side of the body 11. Thus, the present disclosure is enabled to better meet requirements of actual applications.

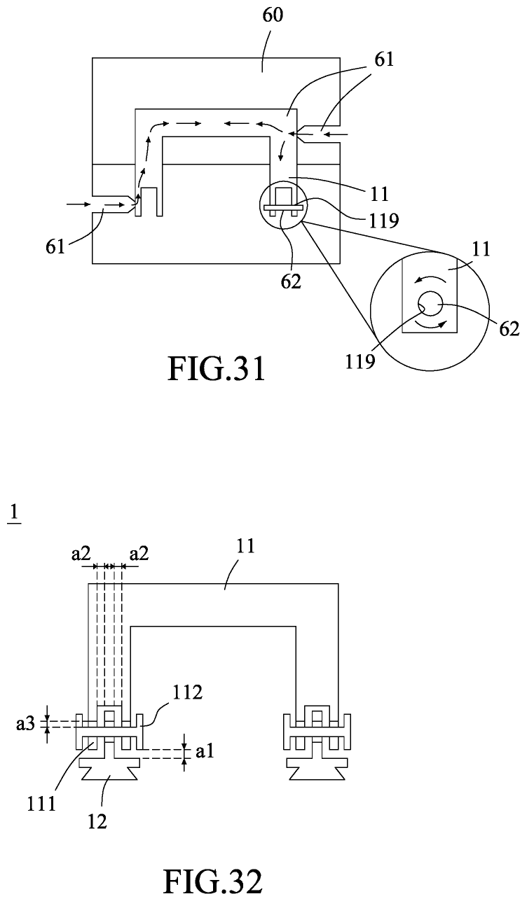

Referring to FIG. 31, as shown, in a preferred specific embodiment of the present disclosure, the body 11 is made in a mold 60 by plastic or metal injection. The mold 60 includes a flow channel 61, so that liquid plastic or metal passes through the flow channel 61, enters the mold 60 and is cured to form the body 11. Thus, the present disclosure is enabled to better meet requirements of actual applications.

In a preferred specific embodiment of the present disclosure, the mold 60 includes a flow channel 61 and a limiting portion 62, so that liquid plastic or metal passes through the flow channel 61, enters the mold 61 and then evades the limiting portion 62 to become cured to form the inserted portion 119 (as the enlarged view on the side of the FIG. 31) of the body 11.

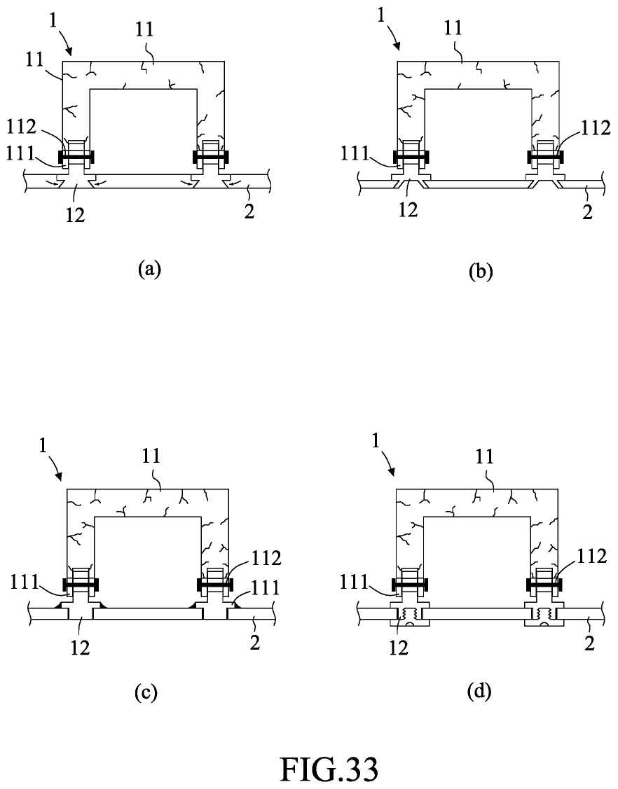

Referring to FIG. 32 and FIG. 33, as shown, in the handle 1 according to a preferred specific embodiment of the present disclosure, a float margin a1 is present between the body 11 and the first fastening portion 111, a float margin a2 is present between the body 11 and the coupler 112, and a float margin a3 is present between the first fastening portion 111 and the coupler 112. In practice, alternatively, the float margin a1 may be provided between the body 11 and the first fastening portion 111, the float margin a2 may be provided between the body 11 and the coupler 112, or the float margin a3 may be provided between the first fastening portion 111 and the coupler 112. In this embodiment, the first fastening portion 111 is two in quantity, and the float margins a1, a2 and a3 are simultaneously provided between the body 11 and the first fastening portion 111, between the body 11 and the coupler 112, and between the first fastening portion 111 and the coupler 112, respectively, wherein the float margins a1, a2 and a3 are between 0.0001 mm and 100 mm.

According to practical use, a float margin (not shown) may further be present between the first fastening portion 111 and the second fastening portion 12, or a float margin may be present between the second fastening portion 12 and the coupler 112.

Moreover, when the first fastening portion 111 is assembled with the coupling counterpart 2, the assembly may be performed by means of rivet connection, expansion connection, welding connection or lock connection according to requirements of the actual assembly.

In this embodiment, the float margins a1, a2 and a3 may provide movement allowances among the body 11, the first fastening portion 111 and the coupler 112 when the first fastening portion 111 is assembled with the coupling counterpart 2, so as to prevent damage or unsatisfactory movement of the body 11.

For example, when the first fastening portion 111 is assembled with the coupling counterpart 2, in the absence of a float margin a (as shown by a to d in FIG. 33), due to an insufficient assembly error between the first fastening portion 111 and the coupling counterpart 2 as well as pulling, twisting, interference, stress concentration or stress pulling during the assembly process, cracking, breaking, deformation, interference, jamming, freezing, restriction, function degradation or function loss of the body 11 made of a plastic or metal material may be resulted (as shown by a to d in FIG. 33).

The float margins a1, a2 and a3 are respectively provided among the body 11, the first fastening portion 111 and the coupler 112, as movement allowances. Thus, when the first fastening portion 111 of the present disclosure is assembled with the coupling counterpart 2, the issues above may be effectively avoided (as shown by a to d in FIG. 33).

In a preferred specific embodiment of the present disclosure, the float margins a1, a2 and a3 are configured to allow a material retaining portion of the first fastening portion 111 to be inserted within float ranges of the float margins a1, a2 and a3 into a hole (e.g., a receiving fastening portion or another through hole) of the coupling counterpart 2 so as to be assembled with the coupling counterpart 2.

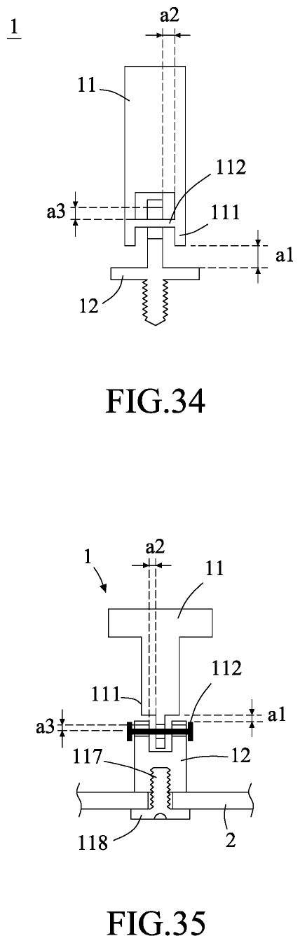

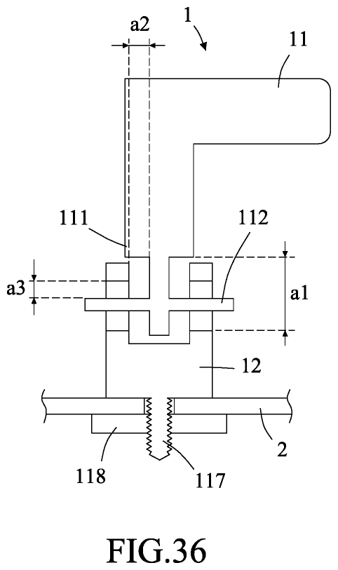

Referring to FIG. 34 to FIG. 36, as shown, in preferred specific embodiments of the present disclosure, the body 11 of the handle 1 may be elongated in shape (as shown in FIG. 34), T-shaped (as shown in FIG. 35) or L-shaped (as shown in FIG. 36), the first fastening portion 111 of these embodiments is one in quantity, and at the same time, the float margins a1, a2 and a3 are provided between the body 11 and the first fastening portion 111, between the body 11 and the coupler 112, and between the first fastening portion 111 and the coupler 112. Moreover, as shown in FIG. 35 and FIG. 36, the first fastening portion 111 includes a fixing connection portion 117. The fixing connection portion 117 is connected to a corresponding fixing connection portion 118, so as to clamp the coupling counterpart 2 by the fixing connection portion 117 and the corresponding fixing connection portion 118 to further assemble the first fastening portion 111 with the coupling counterpart 2. Thus, the present disclosure is enabled to better meet requirements of actual applications.

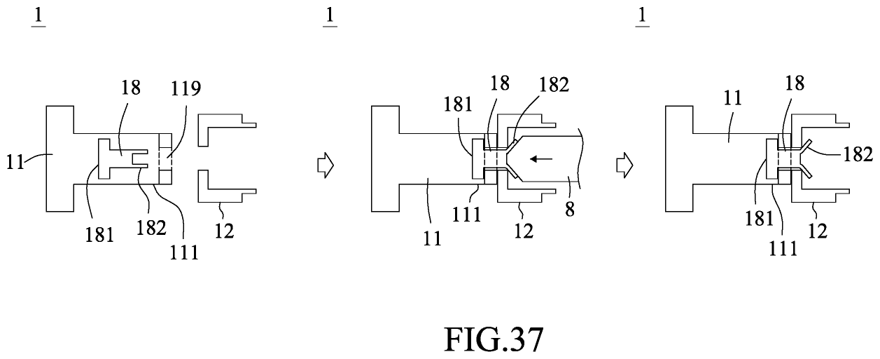

Referring to FIG. 37, as shown, in the handle 1 with a fastening portion according to a preferred specific embodiment of the present disclosure, the body 11 and the second fastening portion 12 are assembled by a coupler 18 in between. The body 11 includes an inserted portion 119, the coupler 18 includes a head 181 and an expansion connection portion 182 and passes through inserted portion 119 of the body 11 and the second fastening portion 12, the head 181 is abutted against the body 11, the expansion connection portion 182 is pressed by an external force from a tool 8, and provided in a deformed manner at the second fastening portion 12 and abutted against the second fastening portion 12, thereby assembling the body 11 with the second fastening portion 12 by the coupler 18. Thus, the present disclosure is enabled to better meet requirements of actual applications.

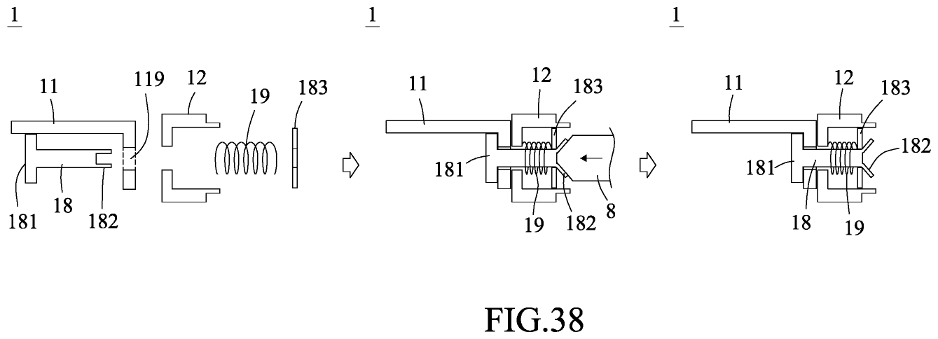

Referring to FIG. 38, as shown, in the handle 1 with a fastening portion according to a preferred specific embodiment of the present disclosure, the body 11 and the second fastening portion 12 are assembled by a coupler 18 in between. The body 11 includes an inserted portion 119, the coupler 18 includes a head 181, an expansion connection portion 182 and a blocking portion 183 and passes through the inserted portion 119 of the body 11 and the second fastening portion 12, the head 181 is abutted against the body 11, the blocking portion 183 is sleeved around the expansion connection portion 182, the expansion connection portion 182 is pressed and deformed by an external force from a tool 8 and abutted against the blocking portion 183, such that the expansion connection portion 182 and the blocking portion 183 are provided in the second fastening portion 12. Thus, the present disclosure is enabled to better meet requirements of actual applications.

In a preferred specific embodiment of the present disclosure, an elastic element 19 is further included. One end of the elastic element 19 presses against the second fastening portion 12, and the other end of the elastic element 19 presses against the blocking portion 183. Thus, the present disclosure is enabled to better meet requirements of actual applications.

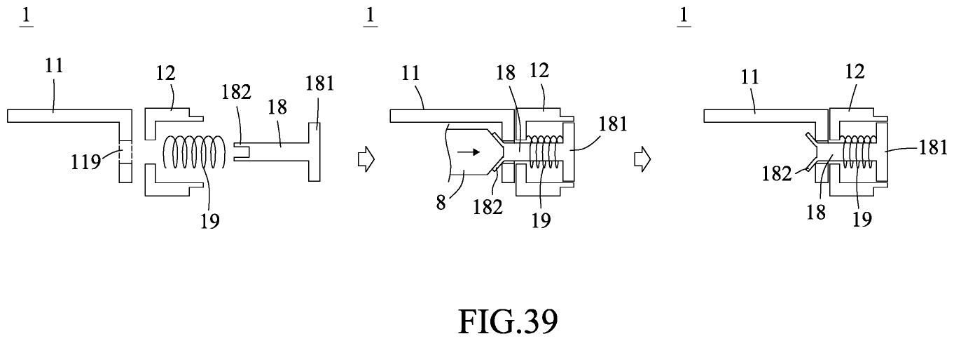

Referring to FIG. 39, as shown, in the handle 1 with a fastening portion according to a preferred specific embodiment of the present disclosure, the body 11 and the second fastening portion 12 are assembled by a coupler 18 in between. The body 11 includes an inserted portion 119, the coupler 18 includes a head 181 and an expansion connection portion 182 and passes through the inserted portion 119 of the body 11 and the second fastening portion 12, the expansion connection portion 182 is pressed and deformed by an external force from a tool 8 and abutted against the body 11, and the head 181 is provided at the second fastening portion 12. Thus, the present disclosure is enabled to better meet requirements of actual applications.

In a preferred specific embodiment of the present disclosure, an elastic element 19 is further included. One end of the elastic element 19 presses against the second fastening portion 12, and the other end of the elastic element 19 presses against the head 181. Thus, the present disclosure is enabled to better meet requirements of actual applications.

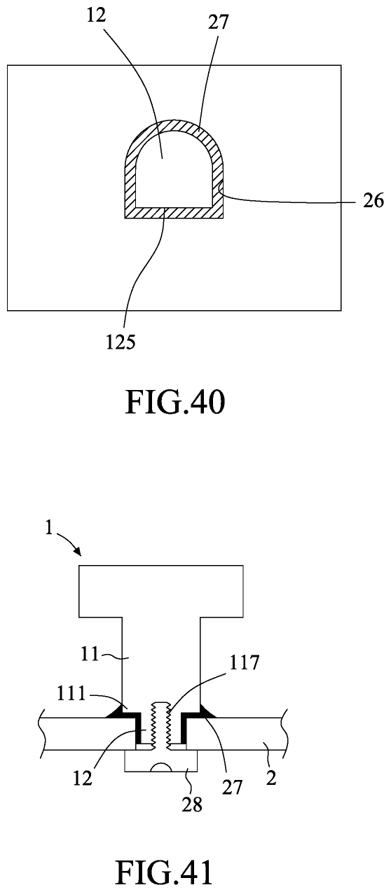

Referring to FIG. 40, as shown, in a preferred specific embodiment of the present disclosure, the second fastening portion 12 includes an anti-rotation portion 125, and the coupling counterpart 2 includes a corresponding anti-rotation portion 26 configured to correspondingly prevent rotation of the second fastening portion 12, position the direction of the second fastening portion 12, or position an assembly position of the second fastening portion 12 and the coupling counterpart 2, so as to stably assemble the second fastening portion 12 at the coupling counterpart 2.

In a preferred specific embodiment of the present disclosure, a solder layer 27 configured to be heated, cooled and then cured is provided between the second fastening portion 12 and the coupling counterpart 2. The solder layer 27 fixedly connects the second fastening portion 12 and the coupling counterpart 2, so as to stably assemble the second fastening portion 12 at the coupling counterpart 2. The coupling counterpart 2 may be a PCB.

In a preferred specific embodiment of the present disclosure, once the coupling counterpart 2 is pressed, the material of the coupling counterpart 2 flows into, enters or is extruded into the second fastening portion 12, so as to stably assemble the second fastening portion 12 at the coupling counterpart 2.

Referring to FIG. 41, as shown, in a preferred specific embodiment of the present disclosure, a corresponding fixing connection portion 28 is further included. The corresponding fixing connection portion 28 fastens the fixing connection portion 117 and is configured to press against the coupling counterpart 2, so as to be anti-rotated and then clamp the coupling counterpart 2 with the body 11, to be welding connected and then clamp the coupling counterpart 2 with the body 11, or to be welding connected, anti-rotated and then clamp the coupling counterpart 2 with the body 11, thereby stably assembling the handle 1 with the coupling counterpart 2.

While the disclosure has been described by way of example and in terms of the embodiments, a person skilled in the art should understood that the embodiments are for illustrating the present disclosure and are not to be construed as limitations to the scope of the present disclosure. It should be noted that, equivalent modifications and substitutions made to the embodiments are to be encompassed within the scope of the present disclosure. Therefore, the protection scope of the present disclosure is to be accorded with the appended claims.

What is claimed is:

1. A manufacturing method of a handle with a fastening portion, the handle comprising a body and a second fastening portion; the body comprising a first fastening portion; the second fastening portion being provided at the body and configured to be receivingly fastened into, assembled into or fitted with a coupling counterpart; wherein the first fastening portion is assembled or connected to the second fastening portion; wherein the body is formed in a mold by plastic or metal injection, and the mold comprises a flow channel so that liquid plastic or metal passes through the flow channel, enters the mold and is cured to form the body; wherein the body and the second fastening portion are assembled by a coupler in between; wherein the body comprises an inserted portion, and the coupler passes through the inserted portion so as to assemble the body and the second fastening portion; wherein the inserted portion of the body is formed in the mold by plastic or metal injection, and the mold comprises the flow channel and a limiting portion so that liquid plastic or metal passes through the flow channel, enters the mold, evades the limiting portion to become cured to form the inserted portion of the body.

2. The manufacturing method of claim 1, wherein the body is provided with a fixing connection portion.

3. The manufacturing method of claim 1, wherein the second fastening portion comprises a neck, the neck is a material storage space, and the body or the second fastening portion is pressed by an external force such that a material of the coupling counterpart enters or flows into the material storage space to enable the handle to be assembled with the coupling counterpart.

4. The manufacturing method of claim 3, wherein the external force further presses a shoulder on the body.

5. The manufacturing method of claim 1, wherein the second fastening portion is pressed by an external force to form a neck, which is a material retaining portion for retaining the coupling counterpart so as to be assembled with the coupling counterpart.

6. The manufacturing method of claim 1, wherein the second fastening portion is a neck, and the body or the neck comprises a welding surface configured to be welded to a corresponding portion of the coupling counterpart.

7. The manufacturing method of claim 1, wherein the handle is picked up by a tool and placed on an assembly position of the coupling counterpart, or the handle is picked up by the tool, compared with the assembly position of the coupling counterpart by a comparison device, and placed on the assembly position of the coupling counterpart.

8. The manufacturing method of claim 1, wherein the first fastening portion is assembled or movably assembled with the body, or is assembled with the body by a coupler.

9. The manufacturing method of claim 1, wherein the body or the second fastening portion comprises an interference portion configured to interfere with or block the coupling counterpart.

10. The manufacturing method of claim 1, wherein a float margin is present between the body and the first fastening portion.

11. The manufacturing method of claim 1, wherein the first fastening portion is assembled with the body by a coupler, and a float margin is present between the body and the coupler, or a float margin is present between the first fastening portion and the coupler.

12. The manufacturing method of claim 1, wherein the second fastening portion comprises an anti-rotation portion, the coupling counterpart comprises a corresponding anti-rotation portion configured to prevent rotation of the second fastening portion, position a direction of the second fastening portion or position an assembly position of the second fastening portion and the coupling counterpart.

13. The manufacturing method of claim 1, wherein a solder layer configured to be heated, cooled and then cured is present between the body, the first fastening portion or the second fastening portion and the coupling counterpart, wherein the coupling counterpart is a printed circuit board (PCB).

14. The manufacturing method of claim 1, wherein a material of the coupling counterpart flows into, enters or is extruded into the second fastening portion once the coupling counterpart is pressed.

15. The manufacturing method of claim 2, further comprising:
a corresponding fixing connection portion, being fastened with the fixing connection portion and configured to press against the coupling counterpart to be anti-rotated and then clamp the coupling counterpart with the body, to be welding connected and then clamp the coupling counterpart with the body, or to be welding connected and anti-rotated and then clamp the coupling counterpart with the body.

16. The manufacturing method of claim 2, wherein the first fastening portion or the second fastening portion is movably assembled with the body, the first fastening portion or the second fastening portion is fixedly assembled with the body, or the first fastening portion or the second fastening portion is a formed integral with the body.

17. The manufacturing method of claim 1, wherein a float margin is present between the body and the first fastening portion, the float margin allowing material retaining portions of two second fastening portions to be inserted within a float range of the float margin into two holes of the coupling counterpart so as to be assembled with the coupling counterpart.

18. The manufacturing method of claim 1, wherein a float margin is present between the body and the first fastening portion, the float margin allowing a material retaining portion of the second fastening portion to be inserted within a float range of the float margin into a hole of the coupling counterpart so as to be assembled with the coupling counterpart.

19. The manufacturing method of claim 1, wherein a float margin is present between the first fastening portion and the second fastening portion.

20. The manufacturing method of claim 1, wherein the first fastening portion and the second fastening portion are assembled by the coupler, and a float margin is present between the first fastening portion and the coupler or a float margin is present between the second fastening portion and the coupler.
